(19) United States
(12) Patent Application Publication
(10) Pub. No.: US 2014/0063201 A1
(43) Pub. Date: Mar. 6, 2014

(54) STEREOSCOPIC ENDOSCOPE SYSTEM

(71) Applicant: CANON KABUSHIKI KAISHA, Tokyo (JP)

(72) Inventor: Minoru Ohkoba, Sagamihara-shi (JP)

(73) Assignee: CANON KABUSHIKI KAISHA, Tokyo (JP)

(21) Appl. No.: 13/951,767

(22) Filed: Jul. 26, 2013

(30) Foreign Application Priority Data
Aug. 29, 2012 (JP) 2012-188981

(51) Int. Cl. H04N 13/02

(52) U.S. Cl. CPC H04N 13/0203
USPC 348/48

(57) ABSTRACT

To obtain various types of information on an observed portion such as a body tissue, white halation is effectively generated in images obtained by imaging the observed portion with a plurality of image sensors. A stereoscopic endoscope system including: a light illuminating unit which irradiates an observed portion with illumination light; an endoscope which has an objective optical system including a plurality of image sensors for receiving reflected light from the observed portion; an image analyzing unit which analyzes images obtained by the objective optical system; and a light amount distribution control unit which controls a light amount distribution of the illumination light based on an analysis result of the images.

### BACKGROUND OF THE INVENTION

1. Field of the Invention

The present invention relates to a stereoscopic endoscope system.

2. Description of the Related Art

As an endoscope for observing the inside of a body cavity, a monocular endoscope is widely used. An electronic endoscope, which is widely in practical use, obtains an image of a body tissue inside the body cavity irradiated with illumination light by using a CCD or other image sensors and displays the obtained image on a monitor for observation.

The illumination light applied to the body tissue passes through the mucous membrane or the like covering the body tissue, and diffuse reflected light reflected by the body tissue under the mucous membrane forms an image on the image sensor to obtain the image, thereby enabling the image of the body tissue to be obtained.

In some cases, however, the illumination light applied to the body tissue is regularly reflected (specularly reflected) by the mucous membrane or the like covering the body tissue, by which the regularly reflected light might be incident on the acceptance surface of the image sensor directly.

The regularly reflected light incident on the acceptance surface of the image sensor has high luminance and exceeds the upper limit of the dynamic range of the CCD. Hence, in the obtained image, there occurs a so-called “white halation” in which the entire area on which the regularly reflected light is incident becomes whitish.

In the case of the white halation, information on the body tissue inside the white halation area is not reflected on the obtained image and further the white halation is likely to interfere with the observation of an area other than the white halation area.

In addition to the monocular endoscope described above, a compound-eye stereoscopic endoscope also begins to be practically used. The stereoscopic endoscope has a plurality of image sensors different in imaging location at the tip of the endoscope with a parallax between the plurality of image sensors. Specifically, in a twin-lens stereoscopic endoscope, as a human observes an image with the naked eye, an image sensor corresponding to the left eye and an image sensor corresponding to the right eye obtain images with parallax, thereby enabling stereoscopic information with parallax to be acquired.

Also in this type of compound-eye stereoscopic endoscope, white halation occurs due to regularly reflected light in the same manner as the monocular endoscope described above. Particularly, in the compound-eye stereoscopic endoscope, it should be noted that white halation occurs in each image obtained by the plurality of image sensors.

In a compound-eye stereoscopic endoscope, unless white halation caused by regularly reflected light observed by each of the plurality of image sensors overlaps white halation observed by others of the image sensors, all body tissue information can be obtained by image sensors in which no white halation occurs.

Further, as described above, white halation occurs due to regularly reflected light on a mucous membrane or the like covering body tissues and therefore includes flatness information on the liquid on the surface layer of the body tissues and the surface of the mucous membrane and information on the direction of the surface.

Accordingly, in the compound-eye stereoscopic endoscope, it is desirable to prevent white halation observed in each of the plurality of image sensors from overlapping white halation observed in others of the image sensors with white halation generated in the obtained image to the extent not affecting the stereoscopic view, instead of removing white halation.

In the case where a body tissue is viewed stereoscopically by using a twin-lens stereoscopic endoscope, each location of the image sensors acts as a reference to depth information. Specifically, the overlap of white halation corresponds to the area of an overlapped area between a pixel area in which white halation occurs in the image obtained by the image sensor corresponding to the left eye and a pixel area in which white halation occurs in the image obtained by the image sensor corresponding to the right eye.

Conventionally, approaches to processing this type of white halation caused by regularly reflected light have been adopted.

For example, there is an endoscope image obtaining method of obtaining an image free from white halation caused by regularly reflected light by irradiating a body tissue with a plurality of illumination light beams and averaging two images obtained by forming images with reflected light from the body tissue. The endoscope image obtaining method, however, does not take into consideration a processing method for reducing white halation in a compound-eye stereoscopic endoscope. Further, in this endoscope image obtaining method, the removal of the white halation overlapped area with the white halation generated in images of at least one image sensors, which is unique to the stereoscopic endoscope, is not necessarily achieved. Moreover, in this endoscope image obtaining method, white halation may disappear in all images in some cases. Moreover, in this endoscope image obtaining method, images in a plurality of light conditions are continuously obtained while changing the states of the illumination lights. Therefore, the device required for this method is expensive.

Moreover, Japanese Patent Application Laid-Open No. 2009-276545 discloses an internal inspection device in which a light emitting unit for emitting illumination light has a mechanism for changing a location and there is incorporated an algorithm for changing a physical location of a light emitting unit so as to reduce regularly reflected light. The internal inspection device in Japanese Patent Application Laid-Open No. 2009-276545 varies the location of the light emitting unit when detecting white halation in an image captured by an objective optical system. In this case, only the size of white halation is evaluated, which leads to an excessive moving distance of the light emitting unit and therefore makes it difficult to secure the minimum brightness of illumination light required for the observation of an object.

### SUMMARY OF THE INVENTION

As described above, in the compound-eye stereoscopic endoscope, it is desirable to prevent white halation observed in each of the plurality of image sensors from overlapping white halation observed in others of the image sensors with white halation generated in the obtained image to the extent not affecting the stereoscopic view, instead of removing white halation.

Therefore, the object of the present invention is to provide a stereoscopic endoscope system capable of generating white halation effectively in an image obtained by imaging an observed portion such as a body tissue by using each of a plurality of image sensors in order to obtain various types of information on the observed portion.

The stereoscopic endoscope system according to the present invention includes: a light illuminating unit which irradiates an observed portion with illumination light; an endoscope having an objective optical system including a plurality of image sensors which receives reflected light from the observed portion; an image analyzing unit which analyzes images obtained by the objective optical system; and a light amount distribution control unit which controls the light amount distribution of illumination light based on a result of analyzing the image.

Further features of the present invention will become apparent from the following description of exemplary embodiments with reference to the attached drawings.

### BRIEF DESCRIPTION OF THE DRAWINGS

FIG. 1 is a schematic perspective view of a stereoscopic endoscope system in the present exemplary embodiment.

FIGS. 2A, 2B, 2C, 2D, 2E, 2F, 2G, 2H and 2I are diagrams illustrating the tip portion of an endoscope of the stereoscopic endoscope system according to the exemplary embodiment and observed images obtained by a right-eye-side imaging system and a left-eye-side imaging system included in the tip portion.

FIG. 3 is a flowchart illustrating imaging processing of the observed portion of a subject using the stereoscopic endoscope system of Example 1 according to the exemplary embodiment.

### DESCRIPTION OF THE EMBODIMENTS

Hereinafter, preferred embodiments of the present invention will now be described in detail according to the accompanying drawings. In some cases, the drawings described hereinafter may be drawn in a scale size different from the actual scale size for easy understanding of the present invention.

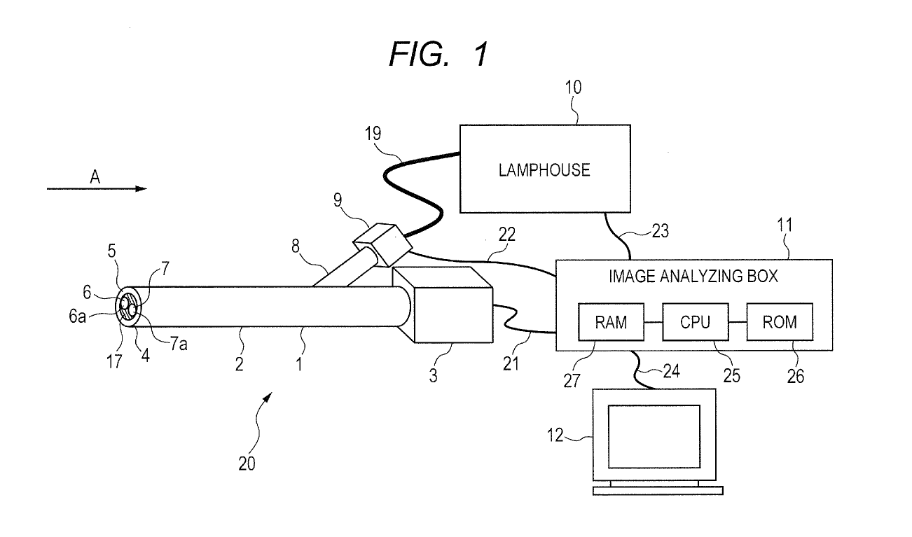

Referring to FIG. 1, there is illustrated a schematic perspective view of a stereoscopic endoscope system 20 in the present exemplary embodiment.

The stereoscopic endoscope system 20 according to the exemplary embodiment is composed of an endoscope 1, a lamphouse 10, an image analyzing box 11 which is an image analyzing unit, and a monitor 12 which is a display unit. The image analyzing box 11 includes a CPU 25, a ROM 26, and a RAM 27.

The endoscope 1 has an inserting portion 2 and a gripping portion 3 with a tip portion 4 of the endoscope 1 provided with a right-eye-side imaging system 6 and a left-eye-side imaging system 7 of the objective optical system 17 and an illumination light outlet 5. In addition, the inserting portion 2 of the endoscope 1 is coupled to an illumination light inlet 8 and a shutter (a light shielding member) 9 is provided so as to be adjacent to the illumination light inlet 8. The lamphouse 10 is connected to the shutter 9 via a cable 19. Moreover, the image analyzing box 11 is connected to the endoscope 1, the shutter 9, and the lamphouse 10 via cables 21, 22, and 23, respectively. The monitor 12 is connected to the image analyzing box 11 via a cable 24.

Although a rigid endoscope is used for the endoscope 1 in the stereoscopic endoscope system 20 of the exemplary embodiment, a flexible endoscope may be used alternatively.

Moreover, in the stereoscopic endoscope system 20 of the exemplary embodiment, the illumination light inlet 8 and the illumination light outlet 5 are connected to each other via optical fibers (not illustrated). As the optical fibers, a plurality of optical fibers small in diameter, which are bundled together on the order of ten thousands, are used in order to guide a good deal of illumination light to the illumination light outlet 5.

In the stereoscopic endoscope system 20 of the exemplary embodiment, illumination light generated in the lamphouse 10 is emitted from the illumination light outlet 5 via the shutter 9, the illumination light inlet 8, and the optical fibers. Therefore, the illumination light outlet 5, the optical fibers, the illumination light inlet 8, and the lamphouse 10 correspond to a light illuminating unit of the exemplary embodiment. Meanwhile, instead of guiding the illumination light from the lamphouse 10 to the illumination light outlet 5, an LED light source (a light emitting element) or the like may be provided at the tip portion 4 of the endoscope 1 so that the LED light source emits illumination light.

Furthermore, in the stereoscopic endoscope system 20 of the exemplary embodiment, the shutter 9 is provided so as to be adjacent to the illumination light inlet 8 in order to enable the light distribution to be changed by changing the lighting area of the illumination light outlet 5 as described later.

When using the stereoscopic endoscope system 20 of the exemplary embodiment, first, a user grips and fixes or handles the gripping portion 3 by his/her hand or equipment or the like in the outside of a subject (not illustrated). Further, the user inserts the inserting portion 2 into the subject and the illumination light generated by the lamphouse 10 is emitted from the illumination light outlet 5 toward an observed portion (not illustrated) inside the subject via the shutter 9, the illumination light inlet 8, and the optical fibers.

The light emitted from the illumination light outlet 5 toward the observed portion is reflected on the observed portion, and the reflected light is received by each of the right-eye-side imaging system 6 and the left-eye-side imaging system 7 of the objective optical system 17 including image sensors (light receiving elements). The reflected light forms an image on the image sensors (not illustrated) such as CCDs provided inside the endoscope 1 by means of lenses 6a and 7a and the obtained observed images are converted to electrical signals. The electrical signals corresponding to the obtained observed images are transmitted to the image analyzing box 11 via a signal cable 21. Thereafter, the electrical signals corresponding to the obtained observed images are transmitted from the image analyzing box 11 to the monitor 12, by which the obtained observed images are displayed on the monitor 12.

Although the right-eye-side imaging system 6 and the left-eye-side imaging system 7 are provided as imaging systems in the stereoscopic endoscope system 20 of the exemplary embodiment, three or more imaging systems may be used as long as two different images with parallax can be obtained.

Furthermore, in the stereoscopic endoscope system 20 of the exemplary embodiment, there is used a white lamp which emits white light in order to grasp the reflected light spectrum from he observed portion in the entire visible light wavelength band as a lamp disposed inside the lamphouse 10. Although a xenon lamp, a halogen lamp, or the like is typically used as the white lamp, particularly the xenon lamp is preferably used which is able to emit light free from extreme unevenness in the intensity from the short wavelength to the long wavelength. Moreover, in some cases, a lamp which emits light of a particular wavelength may be used.

There may be provided a video processor for use in performing image processing such as image correction between the image analyzing box 11 and the monitor 12. Furthermore, a video processor may be used as the image analyzing box 11.

In the stereoscopic endoscope system 20 of the exemplary embodiment, the image analyzing box 11 is a unit which is provided to analyze the obtained observed images and to change the light distribution based on a result of analyzing the obtained observed images as described later. Specifically, the image analyzing box 11 detects the coordinates of the pixels where white halation occurs from the observed images obtained from the right-eye-side imaging system 6 and the left-eye-side imaging system 7 of the objective optical system 17 and identifies the white halation area in each of the observed images. If white halation occurs in the same area of the observed images as a result of the identification, the image analyzing box 11 detects the same area as an overlapped area of white halation. If the overlapped area of white halation is detected, it is necessary to change the light distribution according to the internal algorithm. For this reason, the image analyzing box 11 has a function of transmitting a control signal to the shutter 9 and the lamphouse 10. Specifically, as described later, the shutter 9, the lamphouse 10, and the image analyzing box 11 correspond to the light amount distribution control unit of the exemplary embodiment.

Subsequently, the light distribution will be described. The light distribution in this exemplary embodiment means the light amount distribution of illumination light. Specifically, when thinking in a geometrically-optical manner, the light distribution means the density distribution of a light beam in a space relative to the location of the light source. Therefore, in the change in location of the light source as disclosed in Japanese Patent Application Laid-Open No. 2009-276545, the location of the light source moves only and thus the light distribution does not change. On the other hand, in the present exemplary embodiment, an endoscope with the light distribution having a degree of freedom is used, thereby enabling the light distribution to be changed and controlled.

The light distribution is able to be changed by changing the emission area of the illumination light or sloping the brightness in the emission area. In addition, in the case where a LED light source is provided at the tip portion of the endoscope, the light distribution is able to be changed by making the direction of the light source movable, in other words, adjustable.

Particularly, sloping the brightness in the emission area corresponds to sloping the flux density depending on the emission location in the light distribution, and therefore an arbitrary light distribution is able to be created easily. Therefore, it is possible to form a state in which desired regularly reflected light and diffuse reflected light are contained. Thus, to change the light distribution, it is desirable to slope the brightness in the emission area.

Specifically, a liquid crystal shutter with fine pixels or a variable ND is disposed to operate in the location of the shutter 9, thereby enabling a part of the optical fiber bundle to be shielded. This enables a change in the light distribution of the illumination light emitted from the illumination light outlet 5 of the endoscope 1.

Furthermore, in addition to the operation of the shutter 9, the voltage or the like applied to the lamp inside the lamphouse 10 is changed to adjust the brightness of the lamp, thereby enabling the change in the light distribution of the illumination light so as to provide a wider range of selectable light distribution.

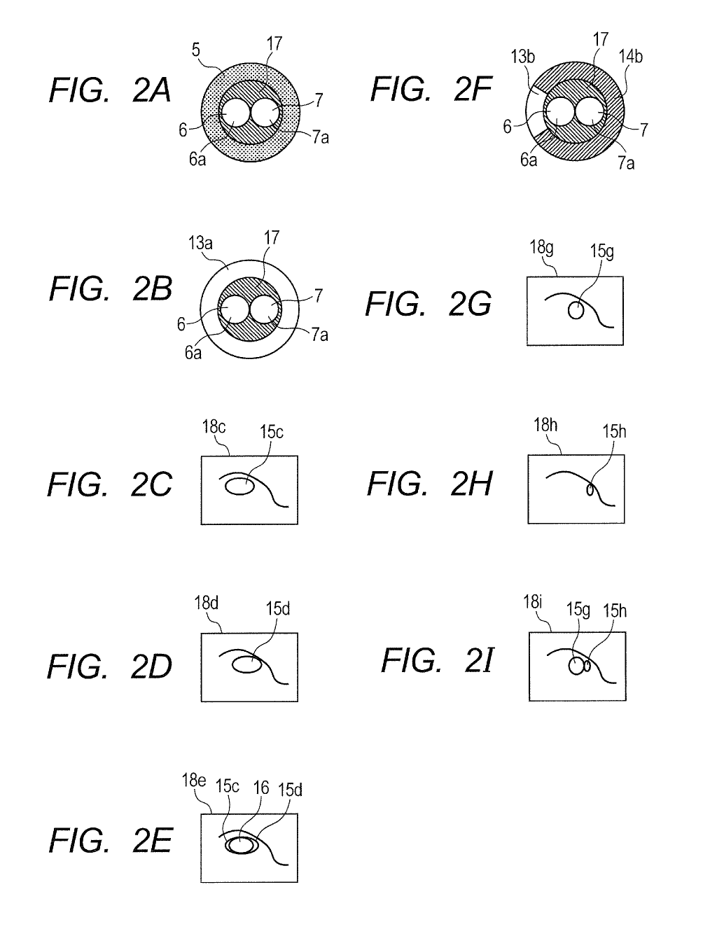

The following describes specific changes in the observed images obtained by the right-eye-side imaging system 6 and the left-eye-side imaging system 7 of the objective optical system 17 caused by the change in the light distribution with reference to FIGS. 2A to 21.

FIG. 2A is a front view of the tip portion 4 of the endoscope 1 viewed from the direction of an arrow A of FIG. 1. First, all optical fibers disposed in the illumination light outlet 5 are lit. FIG. 2B illustrates a state where all areas of the illumination light outlet 5 become lighting areas 13a by lighting the all optical fibers disposed in the illumination light outlet 5. FIGS. 2C and 2D illustrate an observed image 18c obtained by the left-eye-side imaging system 7 and an observed image 18d obtained by the right-eye-side imaging system 6 in the light distribution, respectively. Viewing FIGS. 2C and 2D, the observed image 18c includes a white halation image 15c and the observed image 18d includes a white halation image 15d. FIG. 2E illustrates an observed image 18e made by superimposing the observed image 18c illustrated in FIG. 2C on the observed image 18d illustrated in FIG. 2D. Specifically, the observed image 18e illustrated in FIG. 2E corresponds to the picture of an image felt by a person when looking at the observed image 18c illustrated in FIG. 2C with the left eye and the observed image 18d illustrated in FIG. 2D with the right eye at a time. Viewing FIG. 2E, it is understood that the observed image 18e includes an overlapped portion between the white halation image 15c and the white halation image 15d, namely an overlapped area 16 between the white halation images. In other words, it is understood that a white halation area is formed in the same portion of the observed image 18c and the observed image 18d.

Subsequently, the light distribution is changed. To be more specific, the lighting area of the illumination light outlet 5 is changed by shielding a part of the optical fiber bundle by using the shutter 9. In other words, for example, the lighting area 13a illustrated in FIG. 2B is changed to a lighting area 13b and a non-lighting area 14b corresponding to the shielded optical fibers illustrated in FIG. 2F.

FIGS. 2G and 2H illustrate an observed image 18g obtained by the left-eye-side imaging system 7 and an observed image 18h obtained by the right-eye-side imaging system 6 in the light distribution illustrated in FIG. 2F. Viewing FIGS. 2G and 2H, the observed image 18g includes a white halation image 15g and the observed image 18h includes a white halation image 15h. FIG. 21 illustrates an observed image 18i made by superimposing the observed image 18g illustrated in FIG. 2G on the observed image 18h illustrated in FIG. 2H. Specifically, the observed image 18i illustrated in FIG. 21 corresponds to the picture of an image felt by a person when looking at the observed image 18g illustrated in FIG. 2G with the left eye and the observed image 18h illustrated in FIG. 2H with the right eye at a time. Viewing FIG. 21, it is understood that the observed image 18i does not include an overlapped area between the white halation image 15g and the white halation image 15h.

Therefore, the change from the light distribution illustrated in FIG. 2B to the light distribution illustrated in FIG. 2F enables the elimination of the overlapped area 16 between the white halation images having been included in the observed image 18e illustrated in FIG. 2E as illustrated in FIG. 21.

As a method of changing the light distribution, it is possible to use an algorithm for randomly selecting the light distribution out of selectable light distributions according to the size of the area of the white halation area in the observed image without resort to the shape information or the like of the observed portions obtained in advance. Moreover, conditions can also be set on the light distribution to be selected based on shape information or the like on the observed portion obtained in advance and information on the locations of the white halation images observed in the observed images.

Depending on the structure of the observed portion inside the subject, the light distribution is moved to the right side to reduce the regularly reflected light on the right side of the screen in some cases or the light distribution is moved to the left side in other cases.

As a light amount distribution control unit of the exemplary embodiment, a light modulation element or an EC element may be used. Additionally, it is also possible to use a light emitting element array which functions as a light illuminating unit and as a light amount distribution control unit.

Furthermore, the objective optical system in the exemplary embodiment may be provided with a semiconductor image sensor and optical fibers for guiding the received reflected light to the semiconductor image sensor.

Moreover, the objective optical system in the exemplary embodiment may be provided with a filter which passes light at a given wavelength.

In addition, the endoscope of the exemplary embodiment is able to be provided with an insertion channel into which a treatment tool is inserted.

### EXAMPLES

### Example 1

Example 1 according to the exemplary embodiment will be described hereinafter.

The stereoscopic endoscope system 20 used in Example 1 employs a twin-lens rigid stereoscopic endoscope having a diameter of 10 mm and a length of 250 mm for the endoscope 1. Moreover, a CCD of 960×540 (=518,400) pixels is used for each of the right-eye-side imaging system 6 and the left-eye-side imaging system 7 and a xenon lamp of 300 W is used for the lamp housed in the lamphouse 10.

In addition, a liquid crystal shutter unit is used as a shutter 9. The light distribution was changed by shielding a part of the optical fiber bundle and controlling the brightness of the lamp in the lamphouse 10 with a change in the applied voltage.

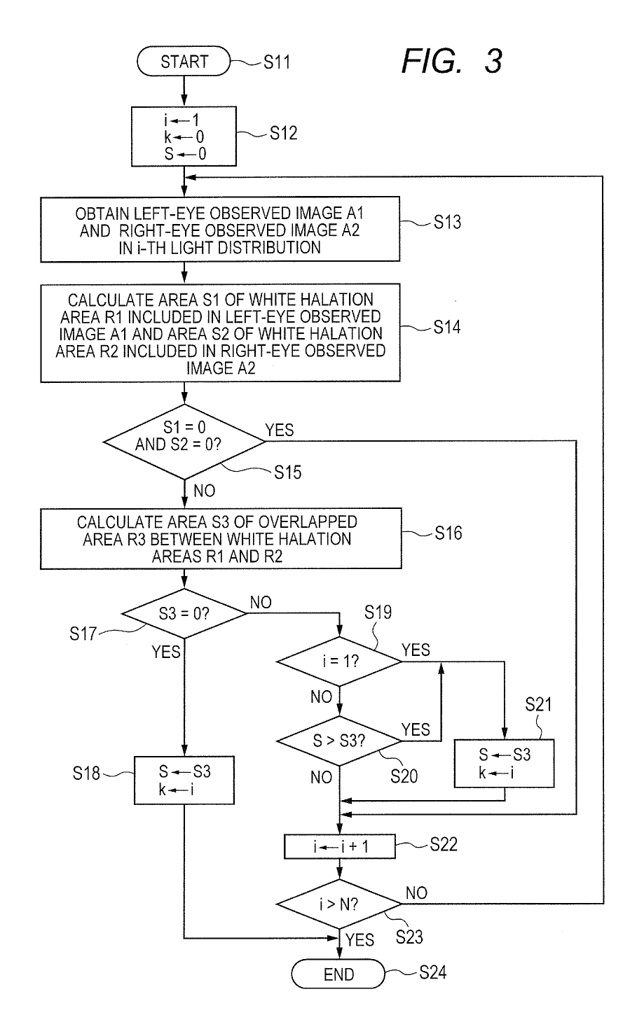

FIG. 3 is a flowchart illustrating imaging processing of an observed portion of a subject using the stereoscopic endoscope system 20 of Example 1. A program for the imaging processing is stored in the ROM (storage medium) 26. The CPU 25 reads the program for the imaging processing from the ROM 26.

First, before starting the imaging processing, N light distributions are previously registered in the RAM 27 of the image analyzing box 11. For example, five types of light distributions are registered in Example 1, which means N=5.

Immediately after the imaging processing is started (S11), the CPU 25 initializes variables i, k, and S to 1, 0, and 0, respectively, first (S12). Subsequently, in the i-th light distribution (i.e., the first light distribution), the right-eye-side imaging system 6 and the left-eye-side imaging system 7 obtain a right-eye observed image A2 and a left-eye observed image A1, respectively (S13). Furthermore, the image analyzing box 11 calculates an area S1 of a white halation area R1 included in the left-eye observed image A1 and an area S2 of a white halation area R2 included in the right-eye observed image A2 based on the obtained observed images (S14).

Subsequently, unless at least one of the calculated areas S1 and S2 is zero (No in S15), the image analyzing box 11 calculates an area S3 of an overlapped area R3 between the white halation area R1 and the white halation area R2 (S16). On the other hand, if the calculated areas S1 and S2 are both zero (Yes in S15), the area S3 is not calculated and the processing proceeds to step S22.

If the calculated area S3 is zero, in other words, if there is no overlapped area R3 (Yes in S17), the value of S3 (i.e., 0) is substituted into the variable S, the value of i (i.e., 1) is substituted into the variable k (S18), and the imaging processing ends (S24).

On the other hand, unless the calculated area S3 is zero, in other words, if there is an overlapped area R3 (No in S17), then it is checked whether the variable i is 1, in other words, whether the imaging processing is performed in the first light distribution (S19). Since the imaging processing is currently performed in the first light distribution (Yes in S19), the value of S3 is substituted into the variable S and the value of i (i.e., 1) is substituted into the variable k (S21).

Subsequently, 1 is added to the variable i (S22: namely, 2 is substituted into i) and it is checked whether the variable i is greater than a variable N (S23). Here, the variable i is 2 and smaller than the variable N (=5) (No in S23), and therefore the processing returns to step S13 to perform imaging processing in the second light distribution, this time.

Then, unless the calculated area S3 is zero (No in S17), it is checked whether the variable i is 1 in step S19. This time, the variable i is 2 and not 1 (No in S19). Therefore, the processing proceeds to step S20 to check whether the area S3 is smaller than the value of the variable S (in other words, the area S3 in the first light distribution). If the area S3 is smaller than the value of the variable S (Yes in S20), the value of S3 is substituted into the variable S and the value of i (i.e., 2) is substituted into the variable k (S21). On the other hand, if the area S3 is greater than the value of the variable S (No in S20), the processing proceeds to step S22.

Then, 1 is added to the variable i (S22: in other words, 3 is substituted into the variable i) to check whether the variable i is greater than the variable N (S23). The variable i is 3 and smaller than the variable N (=5) (No in S23), the processing returns to step S13 to perform the imaging processing in the third light distribution, this time.

After this processing is performed up to the fifth light distribution (i=5), 6 is substituted into the variable i in step S22 and the variable i is greater than the variable N (Yes in S23) and therefore the imaging processing ends (S24).

As a result of this processing, the smallest value of the area S3, namely the area S3 of the smallest overlapped area R3 is substituted into the variable S and a number of the light distribution at that time is substituted into the variable k.

More specifically, in the case of using the k-th light distribution, it is understood that the overlapped area R3 is smallest when at least one of the white halation area R1 and the white halation area R2 is present.

The following describes an example of a result of performing the imaging processing of Example 1 described above. Note here that each area is represented by the number of pixels of an observed image and therefore the result of the imaging processing is represented by the number of pixels where white halation occurs relative to the number of all pixels of the employed CCD, namely 518,400 pixels.

The following table 1 illustrates the number of pixels where white halation occurs and the number of pixels of the overlapped area between white halation images in each of the initial light condition and the selected light condition when the above imaging processing of Example 1 is performed.

TABLE 1

| | | | Number of |
|---|---|---|---|
| | Number of pixels | Number of pixels | pixels of |
| | of white halation | of white halation | overlapped |
| | included in right- | included in left- | area between |
| | eye observed image | eye observed image | white halation |
| | A2 | A1 | images |
| Initial | 52,000 | 50,500 | 40,200 |
| light | | | |
| condition | | | |
| Selected | 51,200 | 50,300 | 0 |
| light | | | |
| condition | | | |

Specifically, in the result illustrated in Table 1, 52,000 pixels of white halation were included in the right-eye observed image A2, 50,500 pixels of white halation were included in the left-eye observed image A1, and the overlapped area between the white halation images, which is an overlap in a binocular image, included 40,200 pixels in the initial light condition (the first light condition).

Additionally, in the light condition (the k-th light condition) selected according to the algorithm illustrated in FIG. 3, the overlapped area between the white halation images was successfully reduced to zero pixel while leaving the white halation of 51,200 pixels included in the right-eye observed image A2 and the white halation of 50,300 pixels included in the left-eye observed image A1. Specifically, this enables all of the body tissue information on the observed portion to be observed by at least one of the right-eye-side imaging system 6 and the left-eye-side imaging system 7. In addition, the white halation of only 51,200 pixels was left in the right-eye observed image and the white halation of only 50,300 pixels was left in the left-eye observed image, thereby enabling information on the surface shape of the observed portion to be acquired, which enabled observation in good condition.

### Comparative Example 1

Subsequently, Comparative Example 1 will be described.

In Comparative Example 1, imaging processing was performed in the same stereoscopic endoscope system 20 as one used in Example 1 by using an algorithm described in Japanese Patent Application Laid-Open No. 2009-276545, instead of the algorithm illustrated in the flowchart of FIG. 3. Specifically, in Comparative Example 1, an algorithm for reducing the area of the white halation area of the observed image, in other words, reducing the regularly reflected light from the observed portion by moving the location of light was employed for each of the right-eye-side imaging system 6 and the left-eye-side imaging system 7.

The following table 2 illustrates the number of pixels where white halation occurs and the number of pixels of the overlapped area between white halation images in each of the initial light condition and the selected light condition when the imaging processing of Comparative Example 1 is performed.

| | | | Number of |
|---|---|---|---|
| | Number of pixels of | Number of pixels of | pixels of |
| | white halation | white halation | overlapped |
| | included in right- | included in left- | area between |
| | eye observed image | eye observed image | white halation |
| | A2 | A1 | images |
| Initial | 52,000 | 50,500 | 40,200 |
| light | | | |
| condition | | | |
| Selected | 0 | 0 | 0 |
| light | | | |
| condition | | | |

Specifically, in the result illustrated in Table 2, 52,000 pixels of white halation were included in the right-eye observed image A2, 50,500 pixels of white halation were included in the left-eye observed image A1, and the overlapped area between white halation images, which is an overlap in a binocular image, included 40,200 pixels in the initial light condition similarly to Example 1. In the algorithm of Japanese Patent Application Laid-Open No. 2009-276545, in other words, in the light condition selected by moving the location of light, however, both of the white halation included in the right-eye observed image A2 and the white halation included in the left-eye observed image A1 were reduced to zero pixel. Therefore, the regularly reflected light portion from the observed portion was not left and information on the mucous membrane flatness of the surface could not be obtained.

### Example 2

Subsequently, Example 2 will be described.

In Example 2, unlike Example 1, it is assumed that a light distribution to be selected next should be determined according to a place where the overlapped area between white halation images occurs when selecting a new light distribution. Specifically, when an image of a convex observed portion is taken in the center, an algorithm according to the location where the overlapped area between white halation images occurs was employed based on a database showing that moving the observed portion to the right is effective to reduce the overlapped area between the white halation images.

In concrete terms, five types of new light distributions were selected on the right side of the observed image if there are many overlapped areas on the right side of the observed image, and five types of new light distributions were selected on the left side of the observed image if there are many overlapped areas on the left side of the observed image. As a result, similarly to Example 1, in the finally-selected light condition, the overlapped area between the white halation images was successfully reduced to zero pixel while leaving the white halation of 51,200 pixels included in the right-eye observed image A2 and the white halation of 50,300 pixels included in the left-eye observed image A1. In addition, although the processing time required before the end of the imaging processing is 0.20 ms in Example 1, the processing time was successfully reduced to 0.12 ms in Example 2.

The present invention is also achieved by the following processing. That is, in the processing, software (program) which implements the functions of the foregoing embodiment is supplied to a system or an apparatus through a network or any storage medium, and a computer (or a CPU, an MPU, or the like) included in the system or the apparatus reads and executes the program.

According to the present invention, not only information on the observed portion, but also flatness information on the surface of the surface layer of the observed portion and information on the direction of the surface can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-188981, filed Aug. 29, 2012, which is hereby incorporated by reference herein in its entirety.

What is claimed is:

1. A stereoscopic endoscope system comprising:
a light illuminating unit which irradiates an observed portion with illumination light;
an endoscope which has an objective optical system including a plurality of image sensors for receiving reflected light from the observed portion;
an image analyzing unit which analyzes images obtained by the objective optical system; and
a light amount distribution control unit which controls a light amount distribution of the illumination light based on an analysis result of the images.

2. The stereoscopic endoscope system according to claim 1, wherein:
the reflected light includes diffuse reflected light and regularly reflected light; and
the light amount distribution control unit controls the light amount distribution of the illumination light so that an image obtained by at least one of the plurality of image sensors includes a white halation area formed by the regularly reflected light and that the white halation area is not formed in the same portion of the images obtained by the plurality of image sensors.

3. The stereoscopic endoscope system according to claim 1, wherein:
the light illuminating unit includes a lamp and a plurality of optical fibers;
the light amount distribution control unit includes a shutter; and
the light amount distribution control unit controls the light amount distribution of the illumination light by adjusting brightness of the lamp and shielding a part of the plurality of optical fibers by using the shutter.

4. The stereoscopic endoscope system according to claim 1, wherein:
the light illuminating unit includes a plurality of LEDs; and
the light amount distribution control unit controls the light amount distribution of the illumination light by adjusting the orientations of the plurality of LEDs.

5. The stereoscopic endoscope system according to claim 1, wherein the light amount distribution control unit includes a light modulation element or an EC element.

6. The stereoscopic endoscope system according to claim 1, comprising a light emitting element array which functions as the light illuminating unit and the light amount distribution control unit.

7. The stereoscopic endoscope system according to claim 1, further comprising a display unit which displays images obtained by the objective optical system.

8. The stereoscopic endoscope system according to claim 1, wherein each of the plurality of image sensors is a semiconductor image sensor.

9. The stereoscopic endoscope system according to claim 8, wherein the objective optical system further includes an optical fiber for guiding reflected light from a lens to the semiconductor image sensor.

10. The stereoscopic endoscope system according to claim 1, wherein the objective optical system further includes a filter which passes light at a given wavelength.

11. The stereoscopic endoscope system according to claim 1, wherein the endoscope further includes an insertion channel into which a treatment tool is inserted.
